(19) United States
(12) Patent Application Publication
(10) Pub. No.: US 2022/0230107 A1
(43) Pub. Date: Jul. 21, 2022

(54) REGIONAL GRIDDING CUMULATIVE ENVIRONMENTAL RISK EVALUATION SYSTEM AND METHOD BASED ON RISK FIELD

(71) Applicants: NANJING UNIVERSITY, Nanjing (CN); CHINESE ACADEMY OF ENVIRONMENTAL PLANNING, Beijing (CN)

(72) Inventors: Jun BI, Nanjing (CN); Guozhi CAO, Beijing (CN); Xiafei ZHOU, Beijing (CN); Zongwei MA, Nanjing (CN); Fang YU, Beijing (CN); Miaomiao LIU, Nanjing (CN); Kunpeng WANG, Beijing (CN); Riyang LIU, Nanjing (CN); Zesheng XU, Beijing (CN); Wenying ZHU, Beijing (CN)

(21) Appl. No.: 17/609,704

(22) PCT Filed: Jan. 11, 2021
(86) PCT No.: PCT/CN2021/071030

§ 371 Date: Nov. 8, 2021

(30) Foreign Application Priority Data
Jan. 14, 2020 (CN) 202010037422.1

(51) Int. Cl. G06Q 10/06; G06Q 50/06; G06Q 50/26

(52) U.S. Cl. CPC G06Q 10/0635; G06F 17/18; G06Q 50/26; G06Q 50/06

(57) ABSTRACT

The present disclosure discloses a regional gridding cumulative environmental risk evaluation system and method based on a risk field, and belongs to the fields of environmental sciences and environmental risks. The cumulative environmental risk evaluation system comprises a data acquisition unit, a data storage unit, an evaluation analysis unit, and a risk visualization unit. The evaluation method includes: establishing a cumulative environmental risk index evaluation model based on a cumulative environmental risk field intensity index, a cumulative environmental risk control mechanism index, and a cumulative environmental risk receptor index, evaluating a cumulative environmental risk through the established model, and determining a grade of the cumulative environmental risk of the evaluation region. By integrating the cumulative environmental risk evaluation system and evaluation method, a cumulative environmental risk can be scientifically and accurately evaluated, so that a powerful technical support is provided for the management work of the cumulative environmental risk.

### CROSS REFERENCE TO RELATED APPLICATIONS

The present application claims the benefit of Chinese Patent Application No. 202010037422.1 filed on Jan. 14, 2020, the contents of which are hereby incorporated by reference.

### TECHNICAL FIELD

The present disclosure belongs to the field of environmental science and environmental risks, and particularly relates to a regional gridding cumulative environmental risk evaluation system and method based on a risk field.

### BACKGROUND

Since the water pollution event occurred in Songhua River in 2005, the risk management of abrupt environmental incidents in China, especially the emergency management of sudden risks, has developed rapidly, and various policy documents have been introduced densely. However, the current “event-driven” environmental risk management mode in China cannot effectively identify specific environmental risk management objectives at all levels, and there is a lack of regional and integrated environmental risk analysis and evaluation methods and results, which causes that the environmental risk base is unclear, and national and regional major environmental risk factors cannot be effectively identified to achieve various environmental risk division, seriously hampering the development of environmental risk priority management for classification and regionalization. With environmental risk evaluation and drawing of a gridding environmental risk map in units of regions, the priority identification, classification, and regionalization management of environmental risks in China can be supported.

The environmental risks include a sudden environmental risk and a cumulative environmental risk. Aiming at regional gridding sudden environmental risk evaluation, China has issued “Recommended Measures for the Risk Evaluation of Abrupt Environmental Incidents in Administrative Regions” as the technical basis of regional sudden environmental risk evaluation based on a risk field. In terms of the cumulative environmental risk, the existing evaluation methods are mainly carried out on the basis of pollution concentration data, population exposure conditions, and corresponding exposure response relationships, and are difficult to apply when evaluating environmental risks lacking information of pollutant exposure and exposure response relationships. Therefore, the existing evaluation methods can generally only be used for cumulative risk evaluation of one or a limited number of pollutants with exposure response relationships. Although Chinese Patent Application No. 201610098851.3 discloses a regional integrated environmental risk evaluation and regionalization method, which evaluates an environmental risk from a macroscopic perspective, this method still relies on data such as pollutant exposure and exposure response relationships.

Therefore, based on the above analysis, the existing method relies on the data such as pollutant exposure and exposure response relationships, can only be used for cumulative risk evaluation of one or a limited number of pollutants with exposure response relationships, is difficult to adapt to gridding cumulative environmental risk evaluation when there are potential multiple pollutants exposure, and is inaccurate in evaluation and poor in universality.

### SUMMARY

Technical Problem: The present disclosure provides a regional gridding cumulative environmental risk evaluation system and method based on a risk field. The system and the method are used for cumulative environmental risk evaluation, can be independent of information of pollutant exposure and exposure response relationships, are suitable for cumulative environmental risk evaluation when there are potential multiple pollutants exposure, are accurate in evaluation, and have high universality, scientificity, and accuracy.

Technical Solution: The regional gridding cumulative environmental risk evaluation system based on the risk field of the present disclosure includes a processor, a memory that stores operational instructions that executed by the processor, where the processor comprises a data acquisition unit, an evaluation analysis unit, and a risk visualization unit, the memory comprises a data storage unit.

The data acquisition unit is configured to acquire environmental risk related data in an evaluation region.

The data storage unit is configured to store the environmental risk related data acquired by the data acquisition unit.

The evaluation analysis unit is provided with a plurality of sub-evaluation analysis units according to categories of environmental media, and is configured to evaluate a cumulative environmental risk of each environmental medium and evaluate a cumulative integrated environmental risk integrating all the environmental media.

The risk visualization unit is configured to generate a cumulative environmental risk map and visually display a cumulative environmental risk condition in the evaluation region.

Further, the evaluation analysis unit includes: a cumulative atmosphere environmental risk evaluation analysis unit, configured to evaluate a cumulative atmosphere environmental risk;

a cumulative water environmental risk evaluation analysis unit, configured to evaluate a cumulative water environmental risk;

a cumulative soil environmental risk evaluation analysis unit, configured to evaluate a cumulative soil environmental risk; and

a cumulative integrated risk evaluation unit, configured to evaluate a cumulative integrated environmental risk integrating atmosphere, water, and soil.

The regional gridding cumulative environmental risk evaluation method based on the risk field of the present disclosure is used for cumulative environmental risk evaluation, using the cumulative environmental risk evaluation system, and specifically includes:

determining an evaluation region, performing grid division on the evaluation region, collecting environmental risk related data including pollution condition data, environmental management statistical data, and geographic information data in the evaluation region using a data acquisition module, and storing the environmental risk related data in the data storage unit;

establishing, for a plurality of environmental media, a cumulative environmental risk index evaluation model based on a cumulative environmental risk field intensity index, a cumulative environmental risk control mechanism index, and a cumulative environmental risk receptor index, and placing the cumulative environmental risk index evaluation model in the evaluation analysis unit for evaluating the cumulative environmental risks, the cumulative environmental risk index evaluation model including cumulative environmental risk indexes corresponding to various environmental media and a cumulative integrated environmental risk index integrating all the categories of environmental media, and a method for calculating the cumulative integrated environmental risk index being:

$$R C = \sqrt[5]{{\sum }_{k = 1}^{m} R {C}_{k}^{5}} ,$$

where RC represents a cumulative integrated environmental risk index of a grid, RCₖ represents a cumulative environmental risk index corresponding to a k^{th} environmental medium of the grid, k is a serial number, and m represents categories of environmental media in the grid; and

performing grade division on the cumulative environmental risks of the evaluation region, determining a grade corresponding to the cumulative environmental risk of each grid in the evaluation region, and drawing a cumulative environmental risk map by the risk visualization unit.

Further, a method for calculating the cumulative environmental risk indexes corresponding to various environmental media is:

$${RC}_{k} = \sqrt[3]{{SF}_{k} \times {SV}_{k} \times {SM}_{k}} , k = 1 … m ,$$

where RCₖ represents a cumulative environmental risk index corresponding to a k^{th} environmental medium of a grid, SFₖ represents a cumulative environmental risk field intensity index corresponding to the k^{th} environmental medium of the grid, SMₖ represents a cumulative environmental risk control mechanism index corresponding to the k^{th} environmental medium of the grid, SVₖ represents a cumulative environmental risk receptor index corresponding to the k^{th} environmental medium of the grid, k is a serial number, and m represents categories of environmental media in the grid.

Further, the environmental media include water, atmosphere, and soil, and the corresponding cumulative environmental risk field intensity indexes include: a cumulative atmosphere environmental risk field intensity index, a cumulative water environmental risk field intensity index, and a cumulative soil environmental risk field intensity index.

The corresponding cumulative environmental risk control mechanism indexes include: a cumulative atmosphere environmental risk control mechanism index, a cumulative water environmental risk control mechanism index, and a cumulative soil environmental risk control mechanism index.

The corresponding cumulative environmental risk receptor indexes include: a cumulative atmosphere environmental risk receptor index, a cumulative water environmental risk receptor index, and a cumulative soil environmental risk receptor index.

Further, a method for calculating the cumulative atmosphere environmental risk field intensity index is:

$$F {A}_{x , y} = {\sum }_{i}^{n} \frac{{DA}_{i} ( {u}_{i} + 1 )}{2}$$

$${DA}_{i} = \sqrt{{SA}_{i} \times {MA}_{i}}$$

$${u}_{i} = \{ \begin{matrix}1 + 0 {k}_{1} + 0 {k}_{2} + 0 j , & {l}_{i} \leq {s}_{1} \\ \frac{{s}_{2} - {l}_{i}}{{s}_{2} - {s}_{1}} + \frac{{l}_{i} - {s}_{1}}{{s}_{2} - {s}_{1}} {k}_{1} + 0 {k}_{2} + 0 j , & {s}_{1} < {l}_{i} \leq {s}_{2} \\ 0 + \frac{{s}_{3} - {l}_{i}}{{s}_{3} - {s}_{2}} {k}_{1} + \frac{{l}_{i} - {s}_{2}}{{s}_{3} - {s}_{2}} {k}_{2} + 0 j , & {s}_{2} < {l}_{i} \leq {s}_{3} \\ 0 + 0 {k}_{1} + \frac{{s}_{4} - {l}_{i}}{{s}_{4} - {s}_{3}} {k}_{2} + \frac{{l}_{i} - {s}_{3}}{{s}_{4} - {s}_{3}} j , & {s}_{3} < {l}_{i} \leq {s}_{4} \\ 0 + 0 {k}_{1} + 0 {k}_{2} + {1}_{j} , & {l}_{i} > {s}_{4}\end{matrix}$$

where FA_{x,y} is a cumulative atmosphere environmental risk field intensity index of a grid (x, y); DAᵢ is a source intensity of an i^{th} cumulative atmosphere environmental risk source; SA_{T} is an environmental risk index of the i^{th} cumulative atmosphere environmental risk source in the evaluation region; MAᵢ is an environmental risk management and control level index of the i^{th} cumulative atmosphere environmental risk source in the evaluation region; uᵢ is a connection degree between the i^{th} risk source and the grid (x, y); lᵢ is a distance between a center point of the grid (x, y) and the i^{th} risk source in km; and i is a serial number, k is a difference coefficient, and j is an opposite of coefficient, where n is the number of cumulative atmosphere environmental risk sources, s₁, s₂, s₃, and s₄ are all constants used for dividing a spatial range in the calculation of the connection degree, and x and y are coordinates of the grid.

Further, after a grid is determined as a water body, the cumulative water environmental risk field intensity index is calculated according to the following formula:

$$F {W}_{x , y} = \{ \begin{matrix}{\sum }_{i = 1}^{n} {DW}_{i} , & 0 \leq {l}_{i} \leq 1 \\ {\sum }_{i = 1}^{n} ( 1 - \frac{{l}_{i}}{10} ) {DW}_{i} , & 1 < {l}_{i} \leq 10 \\ 0 , & 10 , < {l}_{i}\end{matrix} \\ D {W}_{i} = \sqrt{S {W}_{i} \times M {W}_{i}}$$

where FW_{x,y} is a cumulative water environmental risk field intensity index of a grid (x, y); DWᵢ is a source intensity of an i^{th} cumulative water environmental risk source; lᵢ is a distance between a center point of the grid (x, y) and the i^{th} water environmental risk source in km; SWᵢ is an environmental risk index of the i^{th} cumulative water environmental risk source in the evaluation region; and MWᵢ is an environmental risk management and control level index of the i^{th} cumulative water environmental risk source in the evaluation region, where n is the number of cumulative water environmental risk sources, i is a serial number, and x and y are coordinates of the grid.

Further, a method for calculating the cumulative soil environmental risk field intensity index is:

FS_{x,y}=F_{x,y}+FW_{x,y}

where FS_{x,y} is a cumulative soil environmental risk field intensity index of a grid (x, y); FA_{x,y} is a cumulative atmosphere environmental risk field intensity index of the grid (x, y); FW_{x,y} is a cumulative water environmental risk field intensity index of the grid (x, y); and x and y are coordinates of the grid.

Further, the cumulative atmosphere environmental risk control mechanism index, the cumulative water environmental risk control mechanism index, the cumulative soil environmental risk control mechanism index, the cumulative water environmental risk receptor index, and the cumulative soil environmental risk receptor index are determined by a scoring method, evaluation indicators of various environmental media are determined and assigned with weights and scores, such that quantification is performed, and various indicator scores are integrated to calculate a score of each index.

Further, the pollution condition data includes basic information of a pollution enterprise, violation condition and characteristic pollutant monitoring, waste discharge and treatment, and storage of dangerous chemicals. The environmental management statistical data includes environmental governance investment, environmental management law enforcement investment, and environmental problem letters and visits and complaint conditions. The geographic information data includes water body distribution, terrain elevation data, meteorological data, population distribution, and land use types.

Beneficial effects: Compared with the prior art, the present disclosure has the following advantages:

(1) The regional gridding cumulative environmental risk evaluation system based on the risk field of the present disclosure includes a data acquisition unit, a data storage unit, an evaluation analysis unit, and a risk visualization unit, which can complete data acquisition, data storage, environmental risk evaluation, and environmental risk visualization, thus completing the whole environmental risk evaluation process, so that an environmental risk can be managed and regulated scientifically, and the technical support is provided for accurate management work of regionalization classification of cumulative environmental risks.

(2) According to the regional gridding cumulative environmental risk evaluation method based on the risk field of the present disclosure, various data types such as enterprise-level environmental performance data, regional environmental management data, and geographic data are integrated, and grid division is performed on an evaluation region. Then, a cumulative environmental risk index evaluation model is constructed from a cumulative environmental risk field intensity, a cumulative environmental risk control mechanism, and a cumulative environmental risk receptor respectively based on a risk field theory, and grade division is performed according to a score of a cumulative environmental risk index, so that a cumulative environmental risk grade of the evaluation region is determined, a visual map is drawn, and evaluation and visualization of the regional gridding cumulative environmental risk are realized. The method of the present disclosure is independent of exposure data and information of exposure response relationships, so that the cumulative environmental risk can be evaluated macroscopically. Therefore, the method is high in universality and comprehensive in evaluation, and thus can be used as a technical means for identifying a priority of the cumulative environmental risk in China to provide a technical support for accurate management work of regionalization and classification of the cumulative environmental risks.

(3) According to the method of the present disclosure, the difference of different environmental media such as atmosphere, water, and soil is fully considered, a cumulative atmosphere/water/soil environmental risk field intensity index, a cumulative atmosphere/water/soil environmental risk control mechanism index, and a cumulative atmosphere/water/soil environmental risk receptor index in the evaluation region are calculated, the cumulative environmental risk index of each environmental medium in the evaluation region is determined according to the three indexes, and the cumulative integrated environmental risk indexes of all environmental medium, so that the cumulative environmental risk in the evaluation region is integrally evaluated. In particular, in the method of the present disclosure, the cumulative risk of soil is fully considered, so that the cumulative environmental risk evaluation is more accurate.

(4) According to the method of the present disclosure, when part of evaluation indexes are calculated, a scoring method is mainly adopted, different evaluation indicators are set for each environmental medium in the evaluation region, and the indicators are scored and quantified, so that accurate exposure data and exposure response relationship are not required. That is, the environmental risk can be scientifically quantified, and various factors can be integrally considered, not limited to a single indicator, so that the cumulative environmental risk in the evaluation region is scientifically and accurately evaluated, the operation is simple, and the universality is strong. Moreover, when each indicator is weighted, an equal weight form is adopted. The defects of strong subjectivity, high complexity and high difficulty when different weights are adopted are avoided, so that the cumulative environmental risk is evaluated more scientifically and accurately.

(5) According to the method of the present disclosure, the cumulative environmental risk of soil is integrally considered. Since the ways for pollutants to enter a soil environment include atmospheric dry and wet sedimentation, groundwater pollution, and the like, the mechanism is complex, and data is difficult to obtain, the method of the present disclosure determines a calculation method of a cumulative soil environmental risk field intensity so as to reduce the underestimation of the cumulative soil environmental risk under high uncertainty, so that the environmental risk evaluation is more comprehensive and accurate.

(6) According to the method of the present disclosure, a new calculation method for calculating a cumulative integrated environmental risk index is constructed by adopting a Euclidean norm method, and environmental risks of different media are superposed, so as to ensure that the division of the superposed integrated environmental risk is in a reasonable environmental risk grade, the discrimination of the superposed environmental risk index is maintained, the defects of inaccurate evaluation of the cumulative environmental risk and unreasonable risk grade classification of a traditional method are avoided, and the calculation of the cumulative environmental risk of the evaluation region is more scientific and accurate.

### BRIEF DESCRIPTION OF THE DRAWINGS

FIG. 1 is a frame diagram of a regional gridding cumulative environmental risk evaluation system based on a risk field according to the present disclosure.

FIG. 2 is a calculation flow chart of a regional gridding cumulative environmental risk evaluation method based on a risk field according to the present disclosure.

FIG. 3 is a cumulative environmental risk map of Nanjing District drawn based on the method of the present disclosure.

### DETAILED DESCRIPTION

The following further describes the present disclosure in detail with reference to the embodiments and the accompanying drawings in this specification.

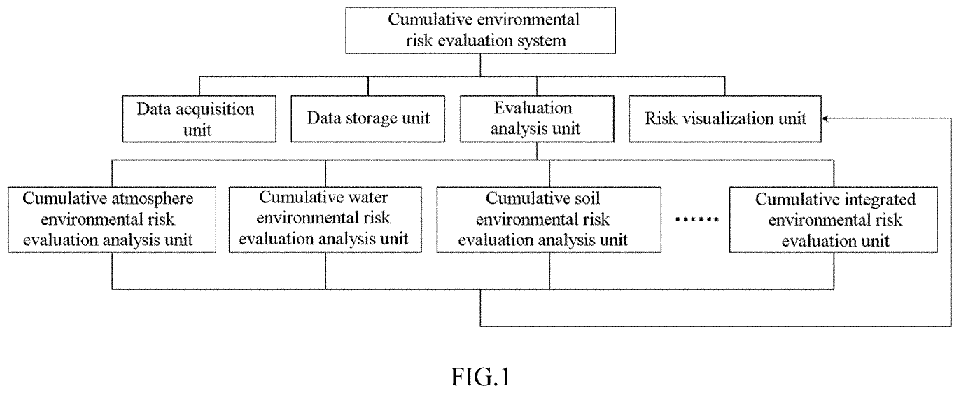

As shown in FIG. 1, the regional gridding cumulative environmental risk evaluation system based on the risk field of the present disclosure includes a processor, a memory that stores operational instructions that executed by the processor, where the processor comprises a data acquisition unit, an evaluation analysis unit, and a risk visualization unit, the memory comprises a data storage unit. The data acquisition unit is configured to acquire environmental risk related data in an evaluation region. The data storage unit is configured to store the environmental risk related data acquired by the data acquisition unit. The evaluation analysis unit is provided with a plurality of sub-evaluation analysis units according to categories of environmental media, and is configured to evaluate a cumulative environmental risk of each environmental medium and evaluate a cumulative integrated environmental risk integrating all the environmental media. The risk visualization unit is configured to generate a cumulative environmental risk map and visually display a cumulative environmental risk condition in the evaluation region.

In an embodiment of the present disclosure, the environmental media include atmosphere, water, and soil. Therefore, the evaluation analysis unit in the cumulative environmental risk evaluation system includes: a cumulative atmosphere environmental risk evaluation analysis unit, configured to evaluate a cumulative atmosphere environmental risk; a cumulative water environmental risk evaluation analysis unit, configured to evaluate a cumulative water environmental risk; a cumulative soil environmental risk evaluation analysis unit, configured to evaluate a cumulative soil environmental risk; and a cumulative integrated risk evaluation unit, configured to evaluate a cumulative integrated environmental risk integrating atmosphere, water, and soil.

The cumulative environmental risk evaluation system can complete data acquisition, data storage, environmental risk evaluation, and environmental risk visualization, thus completing the whole environmental risk evaluation process, so that an environmental risk can be managed and regulated scientifically, and the technical support is provided for accurate management work of regionalization classification of cumulative environmental risks.

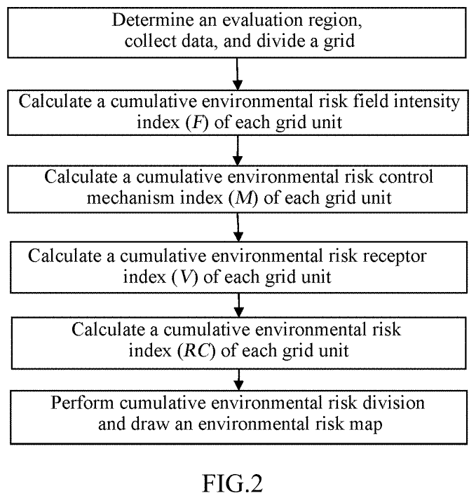

According to the regional gridding cumulative environmental risk evaluation method based on the risk field of the present disclosure, environmental risk evaluation can be performed by adopting the cumulative risk evaluation system of the present disclosure. As shown in FIG. 2, in the method, an evaluation region is firstly determined and is subjected to grid division, environmental risk related data in the evaluation region is collected by adopting the data acquisition module, and the environmental risk related data is stored in the data storage unit. The environmental risk related data in the evaluation region includes: pollution condition data, environmental management statistical data, and geographic information data. The pollution condition data includes basic information of a pollution enterprise, violation condition and characteristic pollutant monitoring, waste discharge and treatment, and storage of dangerous chemicals. The environmental management statistical data includes environmental governance investment, environmental management law enforcement investment, and environmental problem letters and visits and complaint conditions. The geographic information data includes water body distribution, terrain elevation data, meteorological data, population distribution, and land use types. As can be seen from the environmental related data, the data are all state information in the evaluation region, which shows an environmental related state in the evaluation region.

When the evaluation region is subjected to grid division, a coordinate system is established by taking a longitude line passing through the westernmost point of the evaluation region as a Y-axis in a northward positive direction, a latitude line passing through the southernmost point of the evaluation region as an X-axis in an eastward positive direction, and an intersection point of two coordinate axes as an origin. Grid units are divided according to a set resolution in the coordinate system, and parts of the region falling in the grid are numbered. The resolution is typically set to 500 m×500 m and/or 1000 m×1000 m, which ensures that each grid unit contains enough information to reflect an environmental risk in the grid unit and avoids inaccurate evaluation due to too large selection range. After the coordinate system is established and the grids are divided according to the set resolution, any grid may be represented by (x, y) and the coordinates of the grid may be represented by x and y.

For a plurality of environmental media, a cumulative environmental risk index evaluation model is established based on a cumulative environmental risk field intensity index, a cumulative environmental risk control mechanism index, and a cumulative environmental risk receptor index, and the cumulative environmental risk index evaluation model is placed in the evaluation analysis unit for evaluating the cumulative environmental risks. The cumulative environmental risk field intensity index is used to describe a distribution pattern formed by each cumulative environmental risk source in a certain environmental space. The cumulative risk control mechanism index is used to indicate the effectiveness of policies, measures, and technologies for reducing environmental risks in a certain environmental space. The cumulative environmental risk receptor index is used to describe the vulnerability and importance of risk receptors, including population and ecosystem. The three indexes are integrated to establish a cumulative environmental risk index evaluation model. The cumulative environmental risk index evaluation model includes cumulative environmental risk indexes corresponding to all environmental media and a cumulative integrated environmental risk index integrating all environmental media. For example, in an embodiment of the present disclosure, the environmental media include atmosphere, water, and soil. The cumulative environmental risk index corresponding to a single environmental medium includes a cumulative atmosphere environmental risk index, a cumulative water environmental risk index, and a cumulative soil environmental risk index, respectively corresponding to a cumulative atmosphere environmental risk evaluation analysis unit, a cumulative water environmental risk evaluation analysis unit, and a cumulative soil environmental risk evaluation analysis unit of the cumulative environmental risk evaluation system, and a cumulative integrated environmental risk index is obtained by integrating three environmental media: atmosphere, water, and soil, and corresponds to a cumulative integrated environmental risk evaluation analysis unit.

In a specific implementation process, the cumulative environmental risk field intensity index, the cumulative environmental risk control mechanism index, and the cumulative environmental risk receptor index of each environmental medium of each grid in the evaluation region are calculated respectively, and the cumulative environmental risk index corresponding to each environmental medium of the grid and the cumulative integrated environmental risk index integrating all environmental media are determined.

In the embodiment of the present disclosure, the environmental media include water, atmosphere, and soil, so that the corresponding cumulative environmental risk field intensity indexes include: a cumulative atmosphere environmental risk field intensity index, a cumulative water environmental risk field intensity index, and a cumulative soil environmental risk field intensity index. The corresponding cumulative environmental risk control mechanism indexes include: a cumulative atmosphere environmental risk control mechanism index, a cumulative water environmental risk control mechanism index, and a cumulative soil environmental risk control mechanism index. The corresponding cumulative environmental risk receptor indexes include: a cumulative atmosphere environmental risk receptor index, a cumulative water environmental risk receptor index, and a cumulative soil environmental risk receptor index.

Since the soil medium is poor in fluidity, and pollutants are relatively easy to accumulate, the soil medium is indispensable in cumulative environmental risk evaluation. Therefore, in the method of the present disclosure, it is included in the evaluation scope, which makes the evaluation more comprehensive.

The calculation process of the cumulative environmental risk field intensity index, the cumulative environmental risk control mechanism index, and the cumulative environmental risk receptor index is described in conjunction with the flowchart shown in FIG. 2. Since each grid unit is independently performed at the time of evaluation, the calculation process and method of each index are described below in units of one grid at the time of calculation.

(1) A cumulative environmental risk field intensity index (F) of each grid unit is calculated: cumulative environmental risk field intensity indexes of three environmental media are respectively calculated, including a cumulative atmosphere environmental risk field intensity index (FA), a cumulative water environmental risk field intensity index (FW), and a cumulative soil environmental risk field intensity index (FS).

1) A calculation formula of the cumulative atmosphere environmental risk field intensity index (FA) is as shown in (1)-(3):

$$\begin{matrix}F {A}_{x , y} = {\sum }_{i}^{n} \frac{{DA}_{i} ( {u}_{i} + 1 )}{2} & ( 1 ) \\ {DA}_{i} = \sqrt{{SA}_{i} \times {MA}_{i}} & ( 2 ) \\ {u}_{i} = \{ \begin{matrix}1 + 0 {k}_{1} + 0 {k}_{2} + 0 j , & {l}_{i} \leq {s}_{1} \\ \frac{{s}_{2} - {l}_{i}}{{s}_{2} - {s}_{1}} + \frac{{l}_{i} - {s}_{1}}{{s}_{2} - {s}_{1}} {k}_{1} + 0 {k}_{2} + 0 j , & {s}_{1} < {l}_{i} \leq {s}_{2} \\ 0 + \frac{{s}_{3} - {l}_{i}}{{s}_{3} - {s}_{2}} {k}_{1} + \frac{{l}_{i} - {s}_{2}}{{s}_{3} - {s}_{2}} {k}_{2} + 0 j , & {s}_{2} < {l}_{i} \leq {s}_{3} \\ 0 + 0 {k}_{1} + \frac{{s}_{4} - {l}_{i}}{{s}_{4} - {s}_{3}} {k}_{2} + \frac{{l}_{i} - {s}_{3}}{{s}_{4} - {s}_{3}} j , & {s}_{3} < {l}_{i} \leq {s}_{4} \\ 0 + 0 {k}_{1} + 0 {k}_{2} + {1}_{j} , & {l}_{i} > {s}_{4}\end{matrix} & ( 3 )\end{matrix}$$

In Formulas (1)-(3), FA_{x,y} is a cumulative atmosphere environmental risk field intensity index of a grid (x, y); DTᵢ is a source intensity of an i^{th} cumulative atmosphere environmental risk source; SA_{T} is an environmental risk index of the i^{th} cumulative atmosphere environmental risk source in the evaluation region; MAᵢ is an environmental risk management and control level index of the i^{th} cumulative atmosphere environmental risk source in the evaluation region; uᵢ is a connection degree between the i^{th} risk source and the grid (x, y); lᵢ is a distance between a center point of the grid (x, y) and the i^{th} risk source in km; and i is a serial number, k is a difference coefficient, and j is an opposite of coefficient, where n is the number of cumulative atmosphere environmental risk sources. In the embodiment of the present disclosure, k₁=0.5, k₂=−0.5, and j=−1 respectively; s₁, s₂, s₃, and s₄ are all constants for dividing a space range in the calculation of the connection degree, and are 1 km, 3 km, 5 km, and 10 km respectively.

A calculation result is standardized by a range method and adjusted to be within a range of 0-100 as shown in Formula (4):

$${SFA}_{x , y} = \frac{{FA}_{x , y} - {FA}_{min}}{{FA}_{max} - {FA}_{min}} \times 100 \qquad ( 4 )$$

In Formula (4), SFA_{x,y} is a standardized cumulative atmosphere environmental risk field index of the grid (x, y); FAₘₐₓ is a maximum value of cumulative atmosphere environmental risk field intensities of all grids in an evaluation region; and FAₘᵢₙ is a minimum value of the cumulative atmosphere environmental risk field intensities of all the grids in the evaluation region.

Since the situation of a risk source is integrally considered, the calculated cumulative atmosphere environmental risk field intensity index is more scientific and accurate, laying a foundation for accurate cumulative environmental risk evaluation.

Illustratively, an environmental risk index of the cumulative atmosphere environmental risk source in Formula (2) is used for representing the degree of a potential cumulative hazard caused by the risk source. The environmental risk index of the cumulative atmosphere environmental risk source mainly includes a storage chemical substance risk source index and an emission pollutant risk source index. Emission pollutants include heavy metals and volatile organic compounds.

The storage chemical substance risk source index includes a storage chemical substance ecological health index and a population health index. A calculation mode of the ecological health index is: multiplying an existing quantity of each air-related risk substance of the risk source by a corresponding Bioconcentration factor (BCF), and then summing. If the air-related risk substance does not have the BCF, an atmosphere environment ecological health influence is not considered.

A calculation mode of the population health index is: multiplying an existing quantity of each air-related risk substance of the risk source by a corresponding inhalation carcinogenic slope factor, and then summing. If the substance does not have the inhalation carcinogenic slope factor, an atmosphere environment population health influence is not considered.

A calculation mode of the emission pollutant risk source index is: dividing an annual emission of each heavy metal and volatile organic compound in exhaust emissions by a corresponding exhaust emission concentration standard, and then summing.

In order to make the index of each part in the same interval range, a natural logarithm is taken for each part, a result is standardized by using a range method, and adjusted to be within a range of 0-100, and all parts are finally added and summed to obtain the cumulative atmosphere environmental risk source index of the risk source.

An environmental risk management and control level index of the cumulative atmosphere environmental risk source in Formula (3) represents the effectiveness of policies, measures, technologies, and the like for reducing the cumulative environmental risk of the risk source. The environmental risk management and control level index of the cumulative atmosphere environmental risk source may be quantitatively evaluated by adopting a scoring method, and evaluation indicators are shown in Table 1:

TABLE 1
Cumulative Atmosphere Environmental Risk Management and
Control Level Indicators and Evaluation

| Evaluation | | | |
|---|---|---|---|
| Indicators | Evaluation Classification Condition | Weight | Score |
| Collection | No volatile organic primary and | ¼ | 30 |
| mode | secondary materials exist | | |
| of volatile | Volatile organic primary and | | 60 |
| organic | secondary materials exist, but | | |
| compounds | are discharged to | | |
| | a treatment facility | | |
| | Volatile organic primary and | | 100 |
| | secondary materials are free | | |
| | of organic emission and | | |
| | there are no volatile organic | | |
| | treatment facilities | | |
| Automatic | No heavy metals and | ¼ | 30 |
| monitoring | volatile organic compounds are | | |
| data | involved | | |
| of heavy | Heavy metals and volatile organic | | 60 |
| metals | compounds are involved, | | |
| and volatile | and there is automatic monitoring data | | |
| organic | Heavy metals and volatile organic | | 100 |
| compounds | compounds are involved, | | |
| | and there is no automatic monitoring data | | |
| Toxic gas | No toxic and harmful | ¼ | 30 |
| leakage | gases are involved | | |
| monitoring | A toxic and harmful gas | | 60 |
| early | prevention and control early | | |
| warning | warning system is provided | | |
| measures | No toxic and harmful gas | | 100 |
| | prevention and control early | | |
| | warning system is provided | | |
| Emission of | No heavy metals and volatile | ¼ | 30 |
| heavy metals | organic compounds are | | |
| and volatile | involved | | |
| organic | Emission concentrations | | 60 |
| compounds | of heavy metals and volatile organic | | |
| and | compounds reach the standard | | |
| information | Emission concentrations | | 100 |
| of | of heavy metals and volatile | | |
| reaching | organic compounds do | | |
| standard | not reach the standard | | |

The obtained scores of all the indicators are accumulated, the environmental risk management and control level index of the cumulative atmosphere environmental risk source of the risk source is determined, and then the obtained scores are standardized.

2) Cumulative water environmental risk field intensity index (FW): the calculation of a cumulative water environmental risk field intensity is mainly aimed at a water body possibly influenced by cumulative environmental risk substances in the evaluation region, so that the evaluation range is mainly river, lake, reservoir, and other water bodies, and the land is not within the calculation range of a cumulative water environmental risk field. Therefore, the types of the grids need to be classified to determine whether the grids are water body types, as shown in Formula (5):

$$T ( x , y ) = \{ \begin{matrix}1 , & Water body \\ 0 , & Other\end{matrix} \qquad ( 5 )$$

In Formula (5), T(x,y) is a type of a grid (x, y), T(x,y)=1, indicating that the grid is a water body, and T(x,y)=0, indicating that the grid is of another type.

If T(x,y) corresponding to the grid (x, y) is equal to 0, the evaluation of a water environmental risk field of the grid is stopped, and a water environmental risk of the grid is set to 0. If T(x,y) corresponding to the grid (x, y)=1, a water environmental risk field index is calculated by using Formula (6).

$$\begin{matrix}F {W}_{x , y} = \{ \begin{matrix}{\sum }_{i = 1}^{n} {DW}_{i} , & 0 \leq {l}_{i} \leq 1 \\ {\sum }_{i = 1}^{n} ( 1 - \frac{{l}_{i}}{10} ) {DW}_{i} , & 1 < {l}_{i} \leq 10 \\ 0 , & 10 < {l}_{i}\end{matrix} & ( 6 ) \\ {DW}_{i} = \sqrt{{SW}_{i} \times {MW}_{i}} & ( 7 )\end{matrix}$$

In Formulas (6)-(7), FW_{x,y} is a cumulative water environmental risk field intensity of a grid (x, y); DWᵢ is a source intensity of an i^{th} cumulative water environmental risk source; lᵢ is a distance between a center point of the grid (x, y) and the i^{th} water environmental risk source in km; SWᵢ is an environmental risk index of the i^{th} cumulative water environmental risk source in the evaluation region; and MWᵢ is an environmental risk management and control level index of the i^{th} cumulative water environmental risk source in the evaluation region, where n is the number of cumulative water environmental risk sources, and i is a serial number.

A calculation result is standardized by a range method and adjusted to be within a range of 0-100 as shown in Formula (8):

$${SFW}_{x , y} = \frac{{FW}_{x , y} - {FW}_{min}}{{FW}_{max} - {FW}_{min}} \times 100 \qquad ( 8 )$$

In Formula (8), SFW_{x,y} is a standardized cumulative water environmental risk field intensity of the grid (x, y); FWₘₐₓ is a maximum value of water environmental risk field intensities of all grids in the evaluation region; and FWₘᵢₙ is a minimum value of the water environmental risk field intensities of all the grids in the evaluation region.

Since the situation of a risk source is integrally considered, the calculated cumulative water environmental risk field intensity index is more scientific and accurate, laying a foundation for accurate cumulative environmental risk evaluation.

Illustratively, an environmental risk index of the cumulative water environmental risk source in Formula (7) is used for representing the degree of a potential cumulative hazard caused by the risk source. The environmental risk index of the cumulative water environmental risk source mainly includes a storage chemical substance risk source index and an emission pollutant risk source index. Emission pollutants include heavy metals and volatile organic compounds.

The storage chemical substance risk source index includes a storage chemical substance ecological health index and a population health index. A calculation mode of the ecological health index is: multiplying an existing quantity of each water-related risk substance of the risk source by a corresponding BCF, and then summing. If the water-related risk substance does not have the BCF, a water environment ecological health influence is not considered.

A calculation mode of the population health index is: multiplying an existing quantity of each water-related risk substance of the risk source by a corresponding oral carcinogenic slope factor, and then summing. If the substance does not have the oral carcinogenic slope factor, a water environment population health influence is not considered.

A calculation mode of the emission pollutant risk source index is: dividing an annual emission of each heavy metal and petroleum substance in wastewater emissions by a corresponding wastewater emission concentration standard, and then summing.

In order to make the index of each part in the same interval range, a natural logarithm is taken for each part, standardization processing is performed by using a range method, the natural logarithm is adjusted to be within a range of 0-100, and all parts are finally added and summed to obtain the cumulative water environmental risk source index of the risk source.

An environmental risk management and control level index of the cumulative water environmental risk source in Formula (7) represents the effectiveness of policies, measures, technologies, and the like for reducing the cumulative environmental risk of the risk source. The environmental risk management and control level index of the cumulative water environmental risk source may be quantitatively evaluated by adopting a scoring method, and evaluation indicators are shown in Table 2:

TABLE 2
Enterprise Cumulative Water Environmental Risk Management
and Control Level Indicators and Evaluation

| Evaluation | | | |
|---|---|---|---|
| Indicators | Evaluation Classification Condition | Weight | Score |
| Closure | Heavy metals and petroleum | ¼ | 30 |
| measure | substances are not involved | | |
| condition | Heavy metals and petroleum | | 60 |
| | substances are involved, which | | |
| | satisfy: (1) an environmental | | |
| | risk unit is provided with anti- | | |
| | leakage, anti-corrosion, anti-leaching, | | |
| | and anti-loss measures; | | |
| | (2) a drainage switching valve | | |
| | is arranged outside a device | | |
| | cofferdam and a tank farm | | |
| | fire dike (cofferdam), a valve | | |
| | leading to a rainwater system | | |
| | is normally turned off, and a | | |
| | valve leading to an accident | | |
| | liquid storage pool, an emergency | | |
| | accident water pool, a clean | | |
| | wastewater emission buffer pool, | | |
| | or a sewage treatment | | |
| | system is turned on; and (3) the | | |
| | foregoing measures are good | | |
| | in daily management and | | |
| | maintenance, and there is a special | | |
| | person responsible for valve | | |
| | switching or an automatic | | |
| | switching facility is arranged to | | |
| | ensure that initial rainwater, | | |
| | leakages and polluted fire-fighting | | |
| | water are discharged into a | | |
| | sewage system | | |
| Monitoring | Heavy metals and petroleum | | 100 |
| condition | substances are involved, and any | | |
| of heavy | of the requirements above is not met | | |
| metals and | Heavy metals and petroleum | ¼ | 25 |
| petroleum | substances are not involved | | |
| substances | Heavy metals and petroleum | | 50 |
| | substances are involved, and are | | |
| | monitored on line | | |
| | Heavy metals and petroleum | | 75 |
| | substances are involved, and are | | |
| | subjected to enterprise self-test | | |
| | or entrusted monitoring or | | |
| | supervised monitoring | | |
| | Heavy metals and petroleum | | 100 |
| | substances are involved without | | |
| | any monitoring | | |
| Risk | No production wastewater | ¼ | 30 |
| prevention | is generated or discharged | | |
| and control | Wastewater is discharged, and | | 60 |
| measures | any of the requirements below is | | |
| of | met: (1) polluted circulating | | |
| production | cooling water, rainwater, fire | | |
| wastewater | water, and the like are discharged | | |
| treatment | into a production wastewater | | |
| system | system or an independent | | |
| | treatment system; (2) a monitoring | | |
| | pool is arranged before the | | |
| | production wastewater is | | |
| | discharged, and unqualified | | |
| | wastewater can be sent to a | | |
| | wastewater processing facility | | |
| | for treatment; (3) if polluted | | |
| | clean wastewater or rainwater | | |
| | of an enterprise enters a | | |
| | wastewater processing system | | |
| | for treatment, an accident water | | |
| | buffering facility should | | |
| | be arranged in the wastewater | | |
| | processing system; and (4) a | | |
| | monitoring and closing facility for | | |
| | a general production wastewater | | |
| | discharge port is provided, and | | |
| | there is a special person responsible | | |
| | for opening and closing to | | |
| | ensure that leakages, polluted | | |
| | fire-fighting water and | | |
| | unqualified wastewater are | | |
| | not discharged outside the plant | | |
| | Wastewater is discharged, and any of the | | 100 |
| | requirements above is not met | | |
| Emission | Heavy metals and petroleum | ¼ | 30 |
| of heavy | substances are not involved | | |
| metals and | Emission concentrations of | | 60 |
| petroleum | heavy metals and petroleum | | |
| substances | substances reach the standard | | |
| and | Emission concentrations of | | 100 |
| information | heavy metals and petroleum | | |
| of reaching | substances do not reach the standard | | |
| standard | | | |

The obtained scores of all the indicators are accumulated, the environmental risk management and control level index of the cumulative water environmental risk source of the risk source is determined, and then the obtained scores are standardized.

3) Cumulative soil environmental risk field intensity index (FS): the cumulative atmosphere environmental risk field intensity and the water environmental risk field intensity in the grid are superposed and calculated, and then standardized to obtain a final cumulative soil environmental risk field intensity of the grid, and a calculation method is shown in Formula (9):

FS_{x,y}=FA_{x,y}+FW_{x,y} (9)

In Formula (9), FS_{x,y} is a cumulative soil environmental risk field intensity of a grid (x, y); FA_{x,y} is a cumulative atmosphere environmental risk field intensity of the grid (x, y); and FW_{x,y} is a cumulative water environmental risk field intensity of the grid (x, y).

A calculation result is standardized by a range method and adjusted to be within a range of 0-100 as shown in Formula (10):

$${SFS}_{x , y} = \frac{{FS}_{x , y} - {FS}_{min}}{{FS}_{max} - {FS}_{min}} \times 100 \qquad ( 10 )$$

In the formula (10), SFS_{x,y} is a standardized cumulative soil environmental risk field intensity of a grid (x, y); FSₘₐₓ is a maximum value of cumulative soil environmental risk field intensities of all grids; and FSₘᵢₙ is a minimum value of the cumulative soil environmental risk field intensities of all the grids.

Since soil medium is poor in fluidity, and pollutants are relatively easy to accumulate, the soil medium is indispensable in cumulative environmental risk evaluation. Therefore, in the method of the present disclosure, the soil medium is included in the evaluation scope. Since the ways for pollutants to enter a soil environment include atmospheric dry and wet sedimentation, groundwater pollution, and the like, the mechanism is complex, and data is difficult to obtain, the method of the present disclosure determines a simplified calculation method of a cumulative soil environmental risk field intensity based on an idea of a maximum credible accident so as to reduce the underestimation of the cumulative soil environmental risk under high uncertainty. According to the method of the present disclosure, an environmental risk of soil is integrally considered, so that the environmental risk evaluation is more comprehensive and accurate.

(2) A cumulative environmental risk control mechanism index (M) of each grid unit is calculated: cumulative environmental risk control mechanism indexes of three environmental media are respectively calculated, including a cumulative atmosphere environmental risk control mechanism index (MA), a cumulative water environmental risk control mechanism index (MW), and a cumulative soil environmental risk control mechanism index (MS).

1) The cumulative atmosphere environmental risk control mechanism index (MA) is quantified by adopting a scoring method, and the evaluation indicators are shown in Table 3:

TABLE 3
Cumulative Atmosphere Environmental Risk Control
Mechanism Evaluation Indicators

| Evaluation | Description | | | |
|---|---|---|---|---|
| Indicators | of Indicators | Evaluation Basis | Weight | Score |
| Investment | Percentage | The proportion of | ¼ | 100 |
| proportion | of | regional exhaust gas | | |
| of | amount of | control investment to GDP | | |
| regional | investment | is less than 0.025% | | |
| exhaust gas | in | The proportion of | | 75 |
| control | industrial | regional exhaust gas | | |
| | exhaust gas | control investment | | |
| | control per | to GDP is more | | |
| | year in an | than or equal to 0.025% | | |
| | administrative | and less than 0.05% | | |
| | region | The proportion of | | 50 |
| | where | regional exhaust gas | | |
| | a grid is | control investment | | |
| | located in | to GDP is more | | |
| | GDP | than or equal to | | |
| | | 0.05% and less than | | |
| | | 0.075% | | |
| | | The proportion of | | 25 |
| | | regional exhaust gas | | |
| | | control investment | | |
| | | to GDP is more | | |
| | | than or equal to 0.075% | | |
| Environ- | Quantity | The quantity ratio | ¼ | 100 |
| mental | ratio | of environmental | | |
| management | of | managers to pollution | | |
| law | environ- | source enterprises in an | | |
| enforcement | mental | administrative region | | |
| investment | managers | where a grid is located | | |
| of | to | is less than 1 | | |
| regional | pollution | The quantity ratio | | 75 |
| enterprises | source | of environmental | | |
| | enterprises | managers to pollution | | |
| | in an | source enterprises in an | | |
| | admin- | administrative region | | |
| | istrative | where a grid is located | | |
| | region where | is more than or | | |
| | a grid is | equal to 1 and | | |
| | located | less than 1.7 | | |
| | | The quantity ratio | | 50 |
| | | of environmental | | |
| | | managers to | | |
| | | pollution source | | |
| | | enterprises in an | | |
| | | administrative region | | |
| | | where a grid is located | | |
| | | is more than or | | |
| | | equal to 1.7 and | | |
| | | less than 2.5 | | |
| | | The quantity ratio | | 25 |
| | | of environmental | | |
| | | managers to | | |
| | | pollution source | | |
| | | enterprises in an | | |
| | | administrative region | | |
| | | where a grid is located | | |
| | | is more than or | | |
| | | equal to 2.5 | | |
| Regional | Ratio of | The ratio of the | ¼ | 100 |
| enterprise | number of | number of enterprises | | |
| violations | enterprises | recorded with | | |
| | recorded | gas-related violations is | | |
| | with | more than 75% | | |
| | gas-related | The ratio of the | | 75 |
| | violations to | number of enterprises | | |
| | total number | recorded with | | |
| | of enterprises | gas-related violations is | | |
| | in an | more than 50% and | | |
| | administrative | less than or equal | | |
| | region where | to 75% | | |
| | a grid is | The ratio of the | | 50 |
| | located | number of enterprises | | |
| | | recorded with | | |
| | | gas-related violations is | | |
| | | more than 25% and | | |
| | | less than or equal | | |
| | | to 50% | | |
| | | The ratio of the | | 25 |
| | | number of enterprises | | |
| | | recorded with | | |
| | | gas-related violations is | | |
| | | less than or | | |
| | | equal to 25% | | |
| Letters and | Number of | The number of | ¼ | 100 |
| visits and | letters and | letters and visits and | | |
| complaints | visits and | complaints in an | | |
| on | complaints | administrative region | | |
| regional | in an | where a grid is | | |
| environmental | administrative | located is more than | | |
| issues | region where | 39,000 | | |
| | a grid is | The number of | | 75 |
| | located | letters and visits and | | |
| | | complaints in an | | |
| | | administrative region | | |
| | | where a grid is | | |
| | | located is more than | | |
| | | 32,000 and less than | | |
| | | or equal to 39,000 | | |
| | | The number of | | 50 |
| | | letters and visits and | | |
| | | complaints in an | | |
| | | administrative region | | |
| | | where a grid is | | |
| | | located is more than | | |
| | | 25000 and less than | | |
| | | or equal to 32000 | | |
| | | The number of | | 25 |
| | | letters and visits and | | |
| | | complaints in an | | |
| | | administrative region | | |
| | | where a grid is | | |
| | | located is less than or | | |
| | | equal to 25,000 | | |

The obtained scores of all the indicators are accumulated, and a cumulative atmosphere environmental risk control mechanism index M_{x,y} in the grid (x, y) is determined. If the evaluated grid (x, y) spans different administrative regions and scores of cumulative atmosphere environmental risk control mechanisms of the administrative regions are inconsistent, the highest score is taken as a final score.

A calculation result is standardized by a range method and adjusted to be within a range of 0-100 as shown in Formula (11):

$${SMA}_{x , y} = \frac{{MA}_{x , y} - {MA}_{min}}{{MA}_{max} - {MA}_{min}} \times 100 \qquad ( 11 )$$

In Formula (11), SMA_{x,y} represents a standardized cumulative atmosphere environmental risk control mechanism index of a grid (x, y), MAₘᵢₙ represents a minimum value of cumulative atmosphere environmental risk control mechanism indexes of all grids, and MAₘₐₓ represents a maximum value of the cumulative atmosphere environmental risk control mechanism indexes of all grids. Illustratively, a percentage system is adopted in the design of the scores of the evaluation indicators. Therefore, in an actual operation, standardization may not be needed. The standardization is used for unification, making the result more accurate.

2) The cumulative water environmental risk control mechanism index (MW) is quantified by adopting a scoring method, and evaluation indicators are shown in Table 4. If the type of the grid is not a water body, i.e., T(x,y) corresponding to a grid (x, y) is equal to 0, the evaluation of a water environmental risk control mechanism of the grid is stopped.

TABLE 4
Cumulative Water Environmental Risk Control Mechanism
Evaluation Indicators

| Evaluation | Description of | | | |
|---|---|---|---|---|
| Indicators | Indicators | Evaluation Basis | Weight | Score |
| Investment | Percentage of | The proportion of | ¼ | 100 |
| proportion | amount of | regional wastewater | | |
| of | investment in | control investment | | |
| regional | industrial | to GDP is less than | | |
| wastewater | wastewater | 0.009% | | |
| control | control per | The proportion of | | 75 |
| | year in an | regional wastewater | | |
| | administrative | control investment | | |
| | region where a | to GDP is more | | |
| | grid is located | than or equal to | | |
| | in GDP | 0.009% and less than | | |
| | | 0.017% | | |
| | | The proportion of | | 50 |
| | | regional wastewater | | |
| | | control investment | | |
| | | to GDP is more | | |
| | | than or equal to | | |
| | | 0.017% and less than | | |
| | | 0.025% | | |
| | | The proportion of | | 25 |
| | | regional wastewater | | |
| | | control investment | | |
| | | to GDP is more | | |
| | | than or equal to 0.025% | | |
| Environ- | Quantity | The quantity ratio | ¼ | 100 |
| mental | ratio | of environmental | | |
| management | of | managers to | | |
| law | environ- | pollution source | | |
| enforcement | mental | enterprises in an | | |
| investment | managers to | administrative region | | |
| of | pollution | where a grid is | | |
| regional | source | located is less than 1 | | |
| enterprises | enterprises in | The quantity ratio | | 75 |
| | an | of environmental | | |
| | administrative | managers to | | |
| | region where a | pollution source | | |
| | grid is located | enterprises in an | | |
| | | administrative region | | |
| | | where a grid is | | |
| | | located is more than or | | |
| | | equal to 1 and | | |
| | | less than 1.7 | | |
| | | The quantity ratio | | 50 |
| | | of environmental | | |
| | | managers to | | |
| | | pollution source | | |
| | | enterprises in an | | |
| | | administrative region | | |
| | | where a grid is located | | |
| | | is more than or | | |
| | | equal to 1.7 and | | |
| | | less than 2.5 | | |
| | | The quantity ratio | | 25 |
| | | of environmental | | |
| | | managers to | | |
| | | pollution source | | |
| | | enterprises in an | | |
| | | administrative region | | |
| | | where a grid is located | | |
| | | is more than or | | |
| | | equal to 2.5 | | |
| Regional | Ratio of | The ratio of the | ¼ | 100 |
| enterprise | number of | number of enterprises | | |
| violations | enterprises | recorded with | | |
| | recorded with | water-related violations | | |
| | water-related | is more than 75% | | |
| | violations to | The ratio of the | | 75 |
| | total | number of enterprises | | |
| | number of | recorded with | | |
| | enterprises in | water-related violations | | |
| | an | is more than 50% | | |
| | administrative | and less than or | | |
| | region where a | equal to 75% | | |
| | grid is located | The ratio of the | | 50 |
| | | number of enterprises | | |
| | | recorded with water- | | |
| | | related violations | | |
| | | is more than 25% | | |
| | | and less than or | | |
| | | equal to 50% | | |
| | | The ratio of the | | 25 |
| | | number of enterprises | | |
| | | recorded with water- | | |
| | | related violations | | |
| | | is less than or | | |
| | | equal to 25% | | |
| Letters and | Number of | The number of letters | ¼ | 100 |
| visits and | letters and | and visits and | | |
| complaints | visits and | complaints in an | | |
| on | complaints | administrative region | | |
| regional | in an | where a grid is | | |
| environmental | administrative | located is more than | | |
| issues | region where a | 39,000 | | |
| | grid is located | The number of | | 75 |
| | | letters and visits and | | |
| | | complaints in an | | |
| | | administrative region | | |
| | | where a grid is | | |
| | | located is more than | | |
| | | 32,000 and less | | |
| | | than or equal to | | |
| | | 39,000 | | |
| | | The number of | | 50 |
| | | letters and visits and | | |
| | | complaints in an | | |
| | | administrative region | | |
| | | where a grid is | | |
| | | located is more than | | |
| | | 25000 and less than | | |
| | | or equal to 32000 | | |
| | | The number of | | 25 |
| | | letters and visits and | | |
| | | complaints in an | | |
| | | administrative region | | |
| | | where a grid is | | |
| | | located is less than or | | |
| | | equal to 25,000 | | |

The scores of all the indicators are accumulated, and a cumulative water environmental risk control mechanism index MW_{x,y} in the grid (x, y) is determined. If the evaluated grid (x, y) spans different administrative regions and scores of cumulative water environmental risk control mechanisms of the administrative regions are inconsistent, the highest score is taken as a final score.

A calculation result is standardized by a range method and adjusted to be within a range of 0-100 as shown in Formula (12):

$${SMW}_{x , y} = \frac{{MW}_{x , y} - {MW}_{min}}{{MW}_{max} - {MW}_{min}} \times 100 \qquad ( 12 )$$

In Formula (12), SMW_{x,y} represents a standardized cumulative water environmental risk control mechanism index of a grid (x, y), MAₘᵢₙ represents a minimum value of cumulative water environmental risk control mechanism indexes of all grids, and MAₘₐₓ represents a maximum value of the cumulative water environmental risk control mechanism indexes of all grids. Illustratively, a percentage system is adopted in the design of the scores of the evaluation indicators. Therefore, in an actual operation, standardization may not be needed. The standardization is used for unification, making the result more accurate.

3) The cumulative soil environmental risk control mechanism index (MS) is quantified by adopting a scoring method, and evaluation indicators are shown in Table 5.

TABLE 5
Cumulative Soil Environmental Risk Control
Mechanism Evaluation Indicators

| Evaluation | Description | | | |
|---|---|---|---|---|
| Indicators | of Indicators | Evaluation Basis | Weight | Score |
| Investment | Percentage of | The proportion of | ¼ | 100 |
| proportion | amount of | regional solid waste | | |
| of | investment in | control investment | | |
| regional | industrial solid | to GDP is less than | | |
| industrial | waste control | 0.0001% | | |
| solid waste | per year in an | The proportion of | | 75 |
| control | administrative | regional solid waste | | |
| | region where a | control investment | | |
| | grid is located | to GDP is more | | |
| | in GDP | than or equal to | | |
| | | 0.0001% and less | | |
| | | than 0.0018% | | |
| | | The proportion of | | 50 |
| | | regional solid waste | | |
| | | control investment | | |
| | | to GDP is more | | |
| | | than or equal to | | |
| | | 0.0018% and less | | |
| | | than 0.0035% | | |
| | | The proportion of | | 25 |
| | | regional solid waste | | |
| | | control investment | | |
| | | to GDP is more | | |
| | | than or equal | | |
| | | to 0.0035% | | |
| Environ- | Quantity ratio | The quantity ratio | ¼ | 100 |
| mental | of | of environmental | | |
| management | environmental | managers to | | |
| law | managers to | pollution source | | |
| enforcement | pollution | enterprises in an | | |
| investment | source | administrative region | | |
| of | enterprises in | where a grid is | | |
| regional | an | located is less than 1 | | |
| enterprises | administrative | The quantity ratio | | 75 |
| | region where a | of environmental | | |
| | grid is located | managers to | | |
| | | pollution source | | |
| | | enterprises in an | | |
| | | administrative region | | |
| | | where a grid is located | | |
| | | is more than or | | |
| | | equal to 1 and | | |
| | | less than 1.7 | | |
| | | The quantity ratio | | 50 |
| | | of environmental | | |
| | | managers to | | |
| | | pollution source | | |
| | | enterprises in an | | |
| | | administrative region | | |
| | | where a grid is located | | |
| | | is more than or | | |
| | | equal to 1.7 and | | |
| | | less than 2.5 | | |
| | | The quantity ratio | | 25 |
| | | of environmental | | |
| | | managers to | | |
| | | pollution source | | |
| | | enterprises in an | | |
| | | administrative region | | |
| | | where a grid is located | | |
| | | is more than or | | |
| | | equal to 2.5 | | |
| Regional | Ratio of | The ratio of the | ¼ | 100 |
| enterprise | number of | number of enterprises | | |
| violations | enterprises | recorded with soil- | | |
| | recorded with | related violations is | | |
| | soil-related | more than 75% | | |
| | violations to | The ratio of the | | 75 |
| | total number | number of enterprises | | |
| | of | recorded with soil- | | |
| | enterprises in | related violations is | | |
| | an | more than 50% and | | |
| | administrative | less than or equal | | |
| | region where a | to 75% | | |
| | grid is located | The ratio of the | | 50 |
| | | number of enterprises | | |
| | | recorded with soil- | | |
| | | related violations is | | |
| | | more than 25% and | | |
| | | less than or equal | | |
| | | to 50% | | |
| | | The ratio of the | | 25 |
| | | number of enterprises | | |
| | | recorded with soil- | | |
| | | related violations is | | |
| | | less than or equal to 25% | | |
| Letters and | Number of | The number of | ¼ | 100 |
| visits and | letters and | letters and visits and | | |
| complaints | visits and | complaints in an | | |
| on | complaints in | administrative region | | |
| regional | an | where a grid is | | |
| environmental | administrative | located is more than | | |
| issues | region where a | 39,000 | | |
| | grid is located | The number of | | 75 |
| | | letters and visits and | | |
| | | complaints in an | | |
| | | administrative region | | |
| | | where a grid is | | |
| | | located is more than | | |
| | | 32,000 and less than or | | |
| | | equal to 39,000 | | |
| | | The number of | | 50 |
| | | letters and visits and | | |
| | | complaints in an | | |
| | | administrative region | | |
| | | where a grid is | | |
| | | located is more than | | |
| | | 25000 and less than | | |
| | | or equal to 32000 | | |
| | | The number of | | 25 |
| | | letters and visits and | | |
| | | complaints in an | | |
| | | administrative region | | |
| | | where a grid is | | |
| | | located is less than or | | |
| | | equal to 25,000 | | |

The scores of all the indicators are accumulated, and a cumulative soil environmental risk control mechanism index MS_{x,y} in the grid (x, y) is determined. If the evaluated grid (x, y) spans different administrative regions and scores of cumulative soil environmental risk control mechanisms of the administrative regions are inconsistent, the highest score is taken as a final score.

A calculation result is standardized by a range method and adjusted to be within a range of 0-100 as shown in Formula (13):

$$S M {S}_{x , y} = \frac{M {S}_{x , y} - M {S}_{min}}{M {S}_{max} - M {S}_{min}} \times 100 \qquad ( 13 )$$

In Formula (13), SMS_{x,y} represents a standardized cumulative soil environmental risk control mechanism index of a grid (x, y), MSₘᵢₙ represents a minimum value of cumulative soil environmental risk control mechanism indexes of all grids, and MSₘₐₓ represents a maximum value of the cumulative soil environmental risk control mechanism indexes of all grids. Illustratively, a percentage system is adopted in the design of the scores of the evaluation indicators. Therefore, in an actual operation, standardization may not be needed. The standardization is used for unification, making the result more accurate.

It can be seen that in the embodiment of the present disclosure, an adopted scoring table is used for evaluating the performance of regional atmosphere environmental risk management and control in the aspects of fund and personnel investment, management effect, and the like, is not limited to a single indicator, and more comprehensively reflects the level of atmosphere, water and soil environmental risk control mechanisms. The indicators in the table are independent of information of exposure data and exposure response relationships, and data is readily available. The reason why an average weight is adopted is that the importance of each score indicator is similar, and if a difference weight is set, the subjectivity is strong, the complexity of the method is greatly increased, and the difficulty of the actual operation is increased. The average weight method can avoid influence on evaluation accuracy caused by over subjectivity. A general framework of an indicator system is consistent with that of atmosphere and water, and reflects the consistency of evaluation, and some indicators also highlight the specificity of a medium and reflect the accuracy of evaluation. Meanwhile, the cumulative soil environmental risk is integrally considered, so that the evaluation is more scientific and comprehensive.

(3) A cumulative environmental risk receptor index (V) of each grid is calculated: cumulative environmental risk receptor indexes of three media are respectively calculated, including a cumulative atmosphere environmental risk receptor index (VA), a cumulative water environmental risk receptor index (VW), and a cumulative soil environmental risk control mechanism index (VS).

1) The cumulative atmosphere environmental risk receptor index (VA) is calculated by using Formulas (14)-(16).

$$\begin{matrix}{VA}_{x , y} = \sqrt{{p}_{x , y} \times {v}_{x , y}} & ( 14 ) \\ {p}_{x , y} = \frac{{pop}_{x , y} - {pop}_{min}}{{pop}_{max} - {pop}_{min}} & ( 15 ) \\ {v}_{x , y} = \frac{{\tilde{v}}_{x , y} - {v}_{min}}{{v}_{max} - {v}_{min}} & ( 16 )\end{matrix}$$

In Formulas (14)-(16), VA_{x,y} is a cumulative atmosphere environmental risk receptor index of a grid (x, y); p_{x,y} is a standardized population index of the grid (x, y); pop_{x,y} is the population in the grid (x, y); popₘₐₓ is a 99-quantile population value (with an extreme value removed) of all grids; popₘᵢₙ is a minimum value of population of all the grids; v_{x,y} is a standardized wind speed index of the grid (x, y); \tilde{v}_{x,y} is an average wind speed (m/s) in the grid (x, y); vₘₐₓ is a 99-quantile wind speed (with an extreme value removed) (m/s) of all the grids; and vₘᵢₙ is a minimum value (m/s) of wind speeds of all the grids. A result is standardized by a range method and adjusted to be within a range of 0-100 as shown in Formula (17):

$${SVA}_{x , y} = \frac{{VA}_{x , y} - {VA}_{min}}{{VA}_{max} - {VA}_{min}} \times 100 \qquad ( 17 )$$

In Formula (17), SVA_{x,y} represents a standardized cumulative atmosphere environmental receptor index of a grid (x, y), VAₘᵢₙ represents a minimum value of cumulative atmosphere environmental receptor indexes of all grids, and VAₘₐₓ represents a maximum value of the cumulative atmosphere environmental receptor indexes of all grids.

2) The cumulative water environmental risk receptor index (VW) is quantified by adopting a scoring method, and evaluation indicators are shown in Table 6. If the type of the grid is not a water body, i.e., T(x,y) corresponding to a grid (x, y) is equal to 0, the evaluation of a water environmental risk receptor of the grid is stopped.

TABLE 6
Cumulative Water Environmental Risk Receptor Index Evaluation Table

| Target | Indicator | Evaluation Basis | Weight | Score |
|---|---|---|---|---|
| Cumulative | River, lake | Grid through which | ½ | 100 |
| water | and | a first-level river, | | |
| environ- | reservoir | lake and reservoir pass | | |
| mental | level | Grid through which | | 80 |
| risk receptor | | a second-level | | |
| vulnerability | | river, lake and reservoir pass | | |
| index | | Grid through which | | 60 |
| | | a third-level river, | | |
| | | lake and reservoir pass | | |
| | | Grid through which | | 40 |
| | | a fourth-level | | |
| | | river, lake and | | |
| | | reservoir pass | | |
| | | Grid through which | | 20 |
| | | a fifth-level river, | | |
| | | lake and reservoir pass | | |
| | Water | Grid through which | ½ | 100 |
| | body | a river, lake and | | |
| | functional | reservoir of class-I water pass | | |
| | region | Grid through which | | 80 |
| | | a river, lake and | | |
| | | reservoir of class-II water pass | | |
| | | Grid through which | | 60 |
| | | a river, lake and | | |
| | | reservoir of class-III water pass | | |
| | | Grid through which | | 40 |
| | | a river, lake and | | |
| | | reservoir of class-IV water pass | | |
| | | Grid through which | | 20 |
| | | a river, lake and | | |
| | | reservoir of class-V-below | | |
| | | water pass | | |

The scores of all the indicators are accumulated, and a cumulative water environmental risk receptor index VW_{x,y} in the grid (x, y) is determined. A calculation result is standardized by a range method and adjusted to be within a range of 0-100 as shown in Formula (18):

$$S {W}_{x , y} = \frac{V {W}_{x , y} - V {W}_{min}}{V {W}_{max} - V {W}_{min}} \times 100 \qquad ( 18 )$$

In Formula (18), SVW_{x,y} represents a standardized cumulative water environmental receptor index of a grid (x, y), VWₘᵢₙ represents a minimum value of cumulative water environmental receptor indexes of all grids, and VWₘₐₓ represents a maximum value of the cumulative water environmental receptor indexes of all grids. Illustratively, a percentage system is adopted in the design of the scores of the evaluation indicators. Therefore, in an actual operation, standardization may not be needed. The standardization is used for unification, making the result more accurate.

When a scoring table is constructed, a water body level and a water body function are selected as evaluation indicators. Therefore, resource conditions and borne human activity intensity of a water environment receptor are integrally evaluated from the perspective of the water body level and function, so that the integrated evaluation is carried out, and the evaluation result is more scientific and accurate.

3) The cumulative soil environmental risk receptor index (VS) is quantified by adopting a scoring method, and evaluation indicators are shown in Table 7.

TABLE 7
Cumulative Soil Environmental Risk Receptor Index Evaluation Table

| Target | Indicator | Description | Weight | Score |
|---|---|---|---|---|
| Cumulative | Land use type | Grid with cultivated land | ½ | 100 |
| soil | | Grid with urban and rural, | | 80 |
| environmental | | industrial and mining, and | | |
| risk receptor | | residential land | | |
| index | | Grid with grassland | | 60 |
| | | Grid with forest land | | 40 |
| | | Grid with unused land type | | 20 |
| | Soil property | Clay | ½ | 100 |
| | | Loam | | 60 |
| | | Sandy soil | | 30 |

The scores of all the indicators are accumulated, and a cumulative soil environmental risk receptor index VS_{x,y} in the grid (x, y) is determined. A calculation result is standardized by a range method and adjusted to be within a range of 0-100 as shown in Formula (19):

$${SVS}_{x , y} = \frac{{VS}_{x , y} - {VS}_{min}}{{VS}_{max} - {VS}_{min}} \times 100 \qquad ( 19 )$$

In Formula (19), SVS_{x,y} represents a standardized cumulative soil environmental receptor index of a grid (x, y), VSₘᵢₙ represents a minimum value of cumulative soil environmental receptor indexes of all grids, and VSₘᵢₙ represents a maximum value of the cumulative soil environmental receptor indexes of all grids. Illustratively, a percentage system is adopted in the design of the scores of the evaluation indicators. Therefore, in an actual operation, standardization may not be needed. The standardization is used for unification, making the result more accurate.

In the constructed scoring table, the human activity intensity to a soil environmental receptor and pollutant diffusion property are integrally evaluated from the aspects of land use type and soil property, so that the integrated evaluation is carried out, and the evaluation result is more scientific and accurate.

(4) The cumulative environmental risk index (RC) of each grid unit is calculated

In the calculation of the cumulative environmental risk index, three aspects of risk source, risk control mechanism and risk receptor should be considered comprehensively to obtain an integrated score. For each grid unit, two aspects of cumulative environmental risk indexes need to be considered, including a cumulative environmental risk index of a single environmental medium and a cumulative integrated environmental risk index integrating all environmental media.

When the cumulative environmental risk index of various environmental media is calculated, the calculation method adopts the following formula (20):

$${RC}_{k} = \sqrt[3]{{SF}_{k} \times {SV}_{k} \times {SM}_{k}} , k = 1 … m , \qquad ( 20 )$$

where RCₖ represents a cumulative environmental risk index corresponding to a k^{th} environmental medium of a certain grid, SFₖ represents a cumulative environmental risk field intensity index corresponding to the k^{th} environmental medium of the certain grid, SMₖ represents a cumulative environmental risk control mechanism index corresponding to the k^{th} environmental medium of the certain grid, SVₖ represents a cumulative environmental risk receptor index corresponding to the k^{th} environmental medium of the certain grid, k is a serial number, and m represents that there are m environmental media. Illustratively, in general, SFₖ, SVₖ, and SMₖ adopt standardized values, and illustratively, certain means one of them.

In the embodiment of the present disclosure, there are three environmental media including atmosphere, water and soil. Therefore, it can be seen that the value of m is 3, and then:

1) A calculation formula (21) of the cumulative atmosphere environmental risk index of each grid is as follows:

$$R C {A}_{x , y} = \sqrt[3]{{SFA}_{x , y} \times {SVA}_{x , y} \times {SMA}_{x , y}} \qquad ( 21 )$$

In Formula (21), RCA_{x,y} is a cumulative atmosphere environmental risk index of a grid (x, y); SFA_{x,y} is a standardized cumulative atmosphere environmental risk field intensity index of the grid (x, y); SVA_{x,y} is a standardized cumulative atmosphere environmental risk receptor index of the grid (x, y); and SVA_{x,y} is a standardized cumulative atmosphere environmental risk control mechanism index of the grid (x, y). Illustratively, if an index indicated by SFA_{x,y}, SVA_{x,y}, or SMA_{x,y} is within a set score range before standardization, e.g., 0-100, the corresponding index value may also use non-normalized data.

2) A calculation formula (22) of the cumulative water environmental risk index of each grid is as follows:

$${RCW}_{x , y} = \sqrt[3]{{SFW}_{x , y} \times {SVW}_{x , y} \times {SMW}_{x , y}} \qquad ( 22 )$$

In Formula (22), RCW_{x,y} is a cumulative water environmental risk index of a grid (x, y); SFW_{x,y} is a standardized cumulative water environmental risk field intensity index of the grid (x, y); SVW_{x,y} is a standardized cumulative water environmental risk receptor index of the grid (x, y); and SMW_{x,y} is a cumulative water environmental risk control mechanism index of the grid (x, y). Illustratively, if an index indicated by SFW_{x,y}, SVW_{x,y}, or SMW_{x,y} is within a set score range before standardization, e.g., 0-100, the corresponding index value may also use non-normalized data.

3) A calculation formula (23) of the cumulative soil environmental risk index of each grid is as follows:

$${RCS}_{x , y} = \sqrt[3]{{SFS}_{x , y} \times {SVS}_{x , y} \times {SMS}_{x , y}} \qquad ( 23 )$$

In Formula (23), RCS_{x,y} is a cumulative soil environmental risk index of a grid (x, y); SFS_{x,y} is a standardized cumulative soil environmental risk field intensity of the grid (x, y); SVS_{xy} is a standardized cumulative soil environmental risk receptor index of the grid (x, y); and SMS_{x,y} is a standardized cumulative soil environmental risk control mechanism index of the grid (x, y). Illustratively, if an index indicated by SFS_{x,y}, SVS_{x,y}, or SMS_{x,y} is within a set score range before standardization, e.g., 0-100, the corresponding index value may also use non-normalized data.

The cumulative integrated environmental risk index integrating all the environmental media is calculated by superposing the cumulative risk indexes of all the environmental media using a Euclidean vector norm calculation method. A general calculation formula is as shown in Formula (24):

$$RC = \sqrt[5]{{\sum }_{k = 1}^{m} {RC}_{k}^{5}} , \qquad ( 24 )$$

where RC represents a cumulative integrated environmental risk index of a grid, RCₖ represents a cumulative environmental risk index corresponding to a k^{th} environmental medium of the grid, k is a serial number, and m represents categories of environmental media in the grid.

Therefore, if there are three environmental media including atmosphere, water and soil in the embodiment of the present disclosure, the calculation method of the cumulative integrated environmental risk index is as follows:

$$R C = \sqrt[5]{{RCA}_{x , y}^{5} + {RCW}_{x , y}^{5} + {RCS}_{x , y}^{5}} \qquad ( 25 )$$

In Formula (25), environmental risks of different media are superposed, so as to ensure that the division of the superposed integrated environmental risk is in a reasonable environmental risk grade, and the discrimination of the superposed environmental risk index is maintained. Therefore, cumulative environmental risks of various environmental media are integrated, so that a cumulative environmental risk of an evaluation region is scientifically and accurately evaluated.

(5) Cumulative environmental risk division and environmental risk map drawing are performed

According to Table 8, the cumulative environmental risk of the evaluation region is subjected to grade division, grids with different RC scores are divided into different environmental risk grades, and then a grade state of the cumulative environmental risk of each grid in the evaluation region is determined.

TABLE 8
Cumulative Environmental Risk Grade Division Standard

| Cumulative Environmental Risk Index | Environmental |
|---|---|
| (Atmosphere/Water/Soil/Integrated) | Risk Grade |
| ≥80 | Very High (VH) |
| [50, 80) | High (H) |
| [40, 50) | Relatively High |
| | (RH) |
| [30, 40) | Medium (M) |
| <30 | Low (L) |

According to the grade division results of the cumulative environmental risks of all the grids, spatial representation is performed on the cumulative environmental risk grades of the evaluation grids by adopting different colors with a GIS spatial representation technology, and environmental risk maps are respectively drawn by adopting a risk visualization unit of the cumulative environmental risk evaluation system. The environmental risk maps include a cumulative atmosphere environmental risk map, a cumulative water environmental risk map, a cumulative soil environmental risk map, and a cumulative integrated environmental risk map. By grading the cumulative environmental risk indexes of the evaluation region and displaying the cumulative environmental risk situation in the evaluation region in a risk map according to the divided grade, scientific environmental risk management of the evaluation region is realized.

In order to further illustrate the accuracy of the method of the present disclosure, the environmental risk is evaluated according to the cumulative integrated environmental risk index in combination with the grades divided in Table 8. The method for calculating a cumulative integrated environmental risk index by adopting the method provided by the present disclosure is compared with a traditional method which mostly adopts Euclidean 2-norm (i.e., square root of sum of squares).

The cumulative atmosphere environmental risk index, the cumulative water environmental risk index, and the cumulative soil environmental risk index are taken as lower limit values of each grade, respectively, as shown in Table 9.

TABLE 9
Comparison of Method of the Present Disclosure with Traditional Method

| Cumulative | Cumulative | Cumulative | Method | |
|---|---|---|---|---|
| Atmosphere | Water | Soil | of the | Traditional |
| Environmental | Environmental | Environmental | Present | Method |
| Risk Index | Risk Index | Risk Index | Disclosure | (2-Norm) |
| 30 | 30 | 30 | 37.37 | 51.96 |
| 40 | 40 | 40 | 49.83 | 69.28 |
| 50 | 50 | 50 | 62.29 | 86.60 |

As can be seen from Table 9, when the cumulative atmosphere, water and soil environmental risk indexes are all 30, which are the lowest values of Grade-medium (M), the score of the cumulative integrated environmental risk index should also be located at Grade-medium (M). The score of the cumulative integrated environmental risk index calculated by using the method of the present disclosure is 37.37, just within an interval of Grade-medium (M). The score of the cumulative integrated environmental risk index calculated by the traditional method is 51.96, which falls within an interval of Grade-relatively high (RH). When the cumulative atmosphere, water and soil environmental risk indexes are all 40, which are the lowest values of Grade-relatively high (RH), the score of the cumulative integrated environmental risk index should also be located at Grade-relatively high (RH). The score of the cumulative integrated environmental risk index calculated by using the method of the present disclosure is 49.83, just within an interval of Grade-relatively high (RH). The score of the cumulative integrated environmental risk index calculated by the traditional method is 69.28, which falls within an interval of Grade-high (H). When the cumulative atmosphere, water and soil environmental risk indexes are all 50, which are the lowest values of Grade-high (H), the score of the cumulative integrated environmental risk index should also be located at Grade-high (H). The score of the cumulative integrated environmental risk index calculated by using the method of the present disclosure is 62.29, just within an interval of Grade-high (H). The score of the cumulative integrated environmental risk index calculated by the traditional method is 86.60, which falls within an interval of Grade-very high (VH). Therefore, it can be seen that the grade of the cumulative environmental risk is overestimated and the discrimination of the superimposed environmental risk indexes is difficult to maintain due to the inaccurate calculation of the traditional method. By using the method of the present disclosure, the grade of the cumulative environmental risk can be accurately estimated and the discrimination of the superimposed environmental risk indexes can be maintained.

By using the method of the present disclosure, the cumulative environmental risk evaluation is performed on Nanjing District, and the specific process is as follows:

In step 1, evaluation region determination, data collection, and grid division are performed: the whole district of Nanjing is selected as an evaluation region, relevant data is collected, and a resolution of 1 km×1 km is adopted for grid division.

In step 2, a grid c is selected, and a standardized cumulative atmosphere environmental risk field intensity index SFA_{c}, water environmental risk field intensity index SFW_{c}, and soil environmental risk field intensity index SFS_{c} of the grid unit are calculated.

Cumulative atmosphere environmental risk field intensity index SFA_{c}: the region has 20 atmospheric pollution sources, a distance between risk source 1 and the grid unit c is less than 1 km, u₁=1, and an atmosphere environmental risk field intensity index of risk source 1 in the grid unit c is 50. Risk field intensity indexes from 20 risk sources to the grid unit c are sequentially calculated and finally summed to obtain SFA_{c}=60.

Cumulative water environmental risk field intensity index SFW_{c}: the grid unit has no water body, so SFW_{c}=0.

Cumulative soil environmental risk field intensity index SFS_{c}: in this case, the cumulative soil environmental risk field intensity index is equal to the cumulative atmosphere environmental risk field intensity index, i.e., SFS_{c} is 60.

In step 3, a cumulative environmental risk control mechanism index (M) of the grid unit c is calculated: with reference to evaluation indicators, a cumulative atmosphere environmental risk control mechanism index MA_{c}, a cumulative water environmental risk control mechanism index MW_{c}, and a cumulative soil environmental risk control mechanism index MS_{c} are calculated as 25, 0, and 50, separately, and are standardized. Of course, since the values are all within a range of 0-100, they may not be standardized.

In step 4, a cumulative environmental risk receptor index (V) of the grid unit c is calculated: in the grid unit c, the population is 500, popₘₐₓ is 2,000, popₘᵢₙ is 10, pop_{c} is calculated as 0.25, v_{c} is calculated as 0.4 similarly, and then a cumulative atmosphere environmental risk receptor index VA_{c} is 0.32, and then standardized to obtain a result of 40. With reference to evaluation indicators, a cumulative water environmental risk receptor index VW_{c} is calculated as 0 and a cumulative soil environmental risk control mechanism index VS_{c} is calculated as 70.

In step 5, a cumulative environmental risk index (RC) of the grid unit c is calculated: the index including cumulative environmental risk indexes corresponding to various environmental media and a cumulative integrated environmental risk index are calculated with reference to Formulas (21)-(25) to obtain RCA_{c} of 40, RCW_{c} of 0, RCS_{c} of 60, and RC of 61.50.

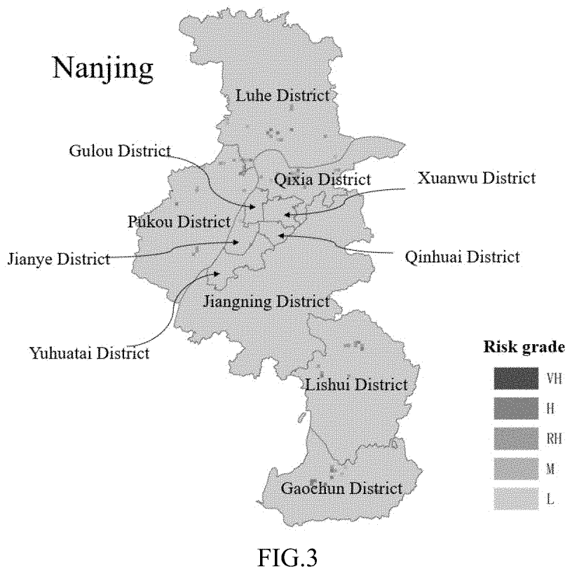

In step 6, cumulative environmental risk division and map drawing are performed according to Table 8: according to step 5, the cumulative environmental risk of the grid belongs to Grade-high (H), after the cumulative environmental risk indexes of all grid units are calculated by repeating steps 2-5, the grids are characterized by adopting different colors on a map with reference to grading standard ratings, and the result is shown in FIG. 3.

The regional gridding cumulative environmental risk evaluation method based on the risk field of the present disclosure is used for cumulative environmental risk evaluation using a constructed evaluation system. The cumulative environmental risk can be scientifically evaluated and managed by the evaluation system. According to the evaluation method, a cumulative environmental risk index evaluation model is constructed from a cumulative environmental risk field intensity, a cumulative environmental risk control mechanism, and a cumulative environmental risk receptor respectively based on a risk field theory, and grade division is performed according to a score of a cumulative environmental risk index, so that a cumulative environmental risk grade of the evaluation region is determined, and a visual map is drawn, thereby realizing the evaluation and visualization of the regional gridding cumulative environmental risk. The evaluation method is independent of information of exposure data and exposure response relationships, so that the cumulative environmental risk can be evaluated macroscopically. Therefore, the method is high in universality, and is more scientific and accurate in evaluation compared to the traditional method, thereby providing a scientific method for the cumulative environmental risk evaluation, and enriching the cumulative environmental risk evaluation theory.

The foregoing embodiments are merely exemplary implementations of the present disclosure. It should be noted that a person of ordinary skill in the art may make some improvement and equivalent replacement without departing from the principle of the present disclosure, and such technical solutions making improvement and equivalent replacement to the claims of the present disclosure shall fall within the protection scope of the present disclosure.

1. A regional gridding cumulative environmental risk evaluation system based on a risk field, comprising a processor, a memory that stores operational instructions that executed by the processor, wherein
the processor comprising a data acquisition unit, an evaluation analysis unit, and a risk visualization unit, the memory comprising a data storage unit;
the data acquisition unit is configured to acquire environmental risk related data in an evaluation region;
the data storage unit is configured to store the environmental risk related data acquired by the data acquisition unit;
the evaluation analysis unit is provided with a plurality of sub-evaluation analysis units according to categories of environmental media, and is configured to evaluate a cumulative environmental risk of each environmental medium and evaluate a cumulative integrated environmental risk integrating all the environmental media; and
the risk visualization unit is configured to generate a cumulative environmental risk map and visually display a cumulative environmental risk condition in the evaluation region.

2. The regional gridding cumulative environmental risk evaluation system based on the risk field according to claim 1, wherein the evaluation analysis unit comprises: a cumulative atmosphere environmental risk evaluation analysis unit, configured to evaluate a cumulative atmosphere environmental risk;
a cumulative water environmental risk evaluation analysis unit, configured to evaluate a cumulative water environmental risk;
a cumulative soil environmental risk evaluation analysis unit, configured to evaluate a cumulative soil environmental risk; and
a cumulative integrated risk evaluation unit, configured to evaluate a cumulative integrated environmental risk integrating atmosphere, water, and soil.

3. A regional gridding cumulative environmental risk evaluation method based on a risk field, for cumulative environmental risk evaluation using the cumulative environmental risk evaluation system according to claim 1, specifically comprising:
determining an evaluation region, performing grid division on the evaluation region, collecting environmental risk related data comprising pollution condition data, environmental management statistical data, and geographic information data in the evaluation region using a data acquisition module, and storing the environmental risk related data in the data storage unit;
establishing, for a plurality of environmental media, a cumulative environmental risk index evaluation model based on a cumulative environmental risk field intensity index, a cumulative environmental risk control mechanism index, and a cumulative environmental risk receptor index, and placing the cumulative environmental risk index evaluation model in the evaluation analysis unit for evaluating the cumulative environmental risks, the cumulative environmental risk index evaluation model comprising cumulative environmental risk indexes corresponding to various environmental media and a cumulative integrated environmental risk index integrating all the categories of environmental media, and a method for calculating the cumulative integrated environmental risk index being:
$$RC = \sqrt[5]{{\sum }_{k = 1}^{m} {RC}_{k}^{5}} ,$$
wherein RC represents a cumulative integrated environmental risk index of a grid, RCₖ-represents a cumulative environmental risk index corresponding to a k^{th} environmental medium of the grid, k is a serial number, and m represents categories of environmental media in the grid; and
performing grade division on the cumulative environmental risks of the evaluation region, determining a grade corresponding to the cumulative environmental risk of each grid in the evaluation region, and drawing a cumulative environmental risk map by the risk visualization unit.

4. The regional gridding cumulative environmental risk evaluation method based on the risk field according to claim 3, wherein a method for calculating the cumulative environmental risk indexes corresponding to various environmental media is:
$${RC}_{k} = \sqrt[3]{{SF}_{k} \times {SV}_{k} \times {SM}_{k}} , k = 1 … m ,$$
wherein RCₖ represents a cumulative environmental risk index corresponding to a k^{th} environmental medium of a grid, SF^{k} represents a cumulative environmental risk field intensity index corresponding to the k^{th} environmental medium of the grid, SM^{k} represents a cumulative environmental risk control mechanism index corresponding to the k^{th} environmental medium of the grid, SV^{k} represents a cumulative environmental risk receptor index corresponding to the k^{th} environmental medium of the grid, k is a serial number, and m represents categories of environmental media in the grid.

5. The regional gridding cumulative environmental risk evaluation method based on the risk field according to claim 3, wherein the environmental media comprise water, atmosphere, and soil, and the corresponding cumulative environmental risk field intensity indexes comprise: a cumulative atmosphere environmental risk field intensity index, a cumulative water environmental risk field intensity index, and a cumulative soil environmental risk field intensity index;
the corresponding cumulative environmental risk control mechanism indexes comprise: a cumulative atmosphere environmental risk control mechanism index, a cumulative water environmental risk control mechanism index, and a cumulative soil environmental risk control mechanism index; and
the corresponding cumulative environmental risk receptor indexes comprise: a cumulative atmosphere environmental risk receptor index, a cumulative water environmental risk receptor index, and a cumulative soil environmental risk receptor index.

6. The regional gridding cumulative environmental risk evaluation method based on the risk field according to claim 5, wherein a method for calculating the cumulative atmosphere environmental risk field intensity index is:
$${FA}_{x , y} = {\sum }_{i}^{n} \frac{{DA}_{i} ( {u}_{i} + 1 )}{2}$$
$${DA}_{i} = \sqrt{{SA}_{i} \times {MA}_{i}}$$
$${u}_{i} = \{ \begin{matrix}1 + 0 {k}_{1} + 0 {k}_{2} + 0 j , & {l}_{i} \leq {s}_{1} \\ \frac{{s}_{2} - {l}_{i}}{{s}_{2} - {s}_{1}} + \frac{{l}_{i} - {s}_{1}}{{s}_{2} - {s}_{1}} {k}_{1} + 0 {k}_{2} + 0 j , & {s}_{1} < {l}_{i} \leq {s}_{2} \\ 0 + \frac{{s}_{3} - {l}_{i}}{{s}_{3} - {s}_{2}} {k}_{1} + \frac{{l}_{i} - {s}_{2}}{{s}_{3} - {s}_{2}} {k}_{2} + 0 j , & {s}_{2} < {l}_{i} \leq {s}_{3} \\ 0 + 0 {k}_{1} + \frac{{s}_{4} - {l}_{i}}{{s}_{4} - {s}_{3}} {k}_{2} + \frac{{l}_{i} - {s}_{3}}{{s}_{4} - {s}_{3}} j , & {s}_{3} < {l}_{i} \leq {s}_{4} \\ 0 + 0 {k}_{1} + 0 {k}_{2} + 1 j , & {l}_{i} > {s}_{4}\end{matrix}$$
wherein FA_{x,y} is a cumulative atmosphere environmental risk field intensity index of a grid (x, y); DAᵢ is a source intensity of an i^{th} cumulative atmosphere environmental risk source; SA_{T} is an environmental risk index of the i^{th} cumulative atmosphere environmental risk source in the evaluation region; MAᵢ is an environmental risk management and control level index of the i^{th} cumulative atmosphere environmental risk source in the evaluation region; uᵢ is a connection degree between the i^{th} risk source and the grid (x, y); lᵢ is a distance between a center point of the grid (x, y) and the i^{th} risk source in km; and i is a serial number, k is a difference coefficient, and j is an opposite of coefficient, wherein n is the number of cumulative atmosphere environmental risk sources, s₁, s₂, s₃, and S₄ are all constants used for dividing a spatial range in the calculation of the connection degree, and x and y are coordinates of the grid.

7. The regional gridding cumulative environmental risk evaluation method based on the risk field according to claim 5, wherein after a grid is determined as a water body, the cumulative water environmental risk field intensity index is calculated according to the following formula:
$$F {W}_{x , y} = \{ \begin{matrix}{\sum }_{i = 1}^{n} D {W}_{i} , & 0 \leq {l}_{i} \leq 1 \\ {\sum }_{i = 1}^{n} ( 1 - \frac{{l}_{i}}{10} ) D {W}_{i} , & 1 < {l}_{i} \leq 10 \\ 0 , & 10 < {l}_{i}\end{matrix} \\ {DW}_{i} = \sqrt{{SW}_{i} \times {MW}_{i}}$$
wherein FW^{x,y} is a cumulative water environmental risk field intensity index of a grid (x, y); DWᵢ is a source intensity of an i^{th} cumulative water environmental risk source; lᵢ is a distance between a center point of the grid (x, y) and the i^{th} water environmental risk source in km; SWᵢ is an environmental risk index of the i^{th} cumulative water environmental risk source in the evaluation region; and MWᵢ is an environmental risk management and control level index of the i^{th} cumulative water environmental risk source in the evaluation region, wherein n is the number of cumulative water environmental risk sources, i is a serial number, and x and y are coordinates of the grid.

8. The regional gridding cumulative environmental risk evaluation method based on the risk field according to claim 5, wherein a method for calculating the cumulative soil environmental risk field intensity index is:
FS_{x,y}=FA_{x,y}+FW_{x,y}
wherein FS_{x,y} is a cumulative soil environmental risk field intensity index of a grid (x, y); FA_{x,y} is a cumulative atmosphere environmental risk field intensity index of the grid (x, y); FW_{x,y} is a cumulative water environmental risk field intensity index of the grid (x, y); and x and y are coordinates of the grid.

9. The regional gridding cumulative environmental risk evaluation method based on the risk field according to claim 5, wherein the cumulative atmosphere environmental risk control mechanism index, the cumulative water environmental risk control mechanism index, the cumulative soil environmental risk control mechanism index, the cumulative water environmental risk receptor index, and the cumulative soil environmental risk receptor index are determined by a scoring method, evaluation indicators of various environmental media are determined and assigned with weights and scores, such that quantification is performed, and various indicator scores are integrated to calculate a score of each index.

10. The regional gridding cumulative environmental risk evaluation method based on the risk field according to claim 3, wherein the pollution condition data comprises basic information of a pollution enterprise, violation condition and characteristic pollutant monitoring, waste discharge and treatment, and storage of dangerous chemicals;
the environmental management statistical data comprises environmental governance investment, environmental management law enforcement investment, and environmental problem letters and visits and complaint conditions; and
the geographic information data comprises water body distribution, terrain elevation data, meteorological data, population distribution, and land use types.
